(19) United States
(12) Patent Application Publication
(10) Pub. No.: US 2014/0283986 A1
(43) Pub. Date: Sep. 25, 2014

(54) RESIN MEMBER WELDING METHOD

(71) Applicant: HONDA MOTOR CO., LTD., Tokyo (JP)

(72) Inventors: Takahiro Kunichi, Wako-shi (JP); Keiichi Sato, Wako-shi (JP)

(73) Assignee: HONDA MOTOR CO., LTD., Tokyo (JP)

(21) Appl. No.: 14/219,323

(22) Filed: Mar. 19, 2014

(30) Foreign Application Priority Data
Mar. 21, 2013 (JP) 2013-057879

(51) Int. Cl. B29C 65/16

(52) U.S. Cl. CPC B29C 65/168
USPC 156/272.8

(57) ABSTRACT

A method for welding laser-impermeable resin members. The resin members are overlapped with each other at least partially, with a light absorber capable of absorbing laser light being interposed therebetween, so as to form an overlapping portion. The light absorber in the overlapping portion is irradiated directly with laser light, and is heated and melted thereby. Heat from the melted light absorber is transferred to the resin members in the overlapping portion, and therefore the resin members are melted in the overlapping portion. The melted overlapping portion is cooled and solidified, whereby the overlapping portion is integrally bonded.

### CROSS-REFERENCE TO RELATED APPLICATION

This application is based upon and claims the benefit of priority from Japanese Patent Application No. 2013-057879 filed on Mar. 21, 2013, the contents of which are incorporated herein by reference.

### BACKGROUND OF THE INVENTION

1. Field of the Invention

The present invention relates to a resin member welding method for welding laser-impermeable resin members with each other.

2. Description of the Related Art

In a known and widely used method, resin members are overlapped with each other, and an overlapping portion of the resin members is irradiated with laser light, whereby the overlapping portion is welded. For example, in Japanese Laid-Open Patent Publication No. 2002-331588, a laser-permeable first resin member and a laser-absorbing second resin member are overlapped with each other to form an overlapping portion, and thereafter, the first resin member is irradiated with laser light in the overlapping portion.

According to this method, laser light is transmitted through the first resin member, introduced to the contact surface of the first and second resin members, absorbed by the second resin member, and converted into heat. The first and second resin members are melted by such heat in the vicinity of the contact surface. Then, irradiation of the laser light is stopped, and the melted first and second resin members are cooled and solidified, whereby the first and second resin members are welded with each other.

Further, in a welding method disclosed in Japanese Patent No. 3827071, a laser-permeable resin member is stacked on another laser-permeable resin member, or a laser-permeable resin member is stacked on a laser-absorbing resin member with a laser light absorber being interposed therebetween, and laser light is introduced through the laser-permeable resin member into the laser light absorber. According to this welding method, when the laser light is absorbed by the laser light absorber, the temperature of the laser light absorber is increased, whereby the two resin members and the laser light absorber are melted in the vicinity of contact surfaces thereof and the resin members are welded.

### SUMMARY OF THE INVENTION

For example, a resin member, which is composed of a carbon fiber-reinforced plastic resin composite (CFRP) or the like, is capable of absorbing a majority of the laser light in the vicinity of the surface. In this case, the laser light cannot be transmitted through the resin member. In other words, the resin member is a laser-impermeable resin member.

Such laser-impermeable resin members cannot be welded with each other according to the methods described in Japanese Laid-Open Patent Publication No. 2002-331588 and Japanese Patent No. 3827071. When the resin member is irradiated with laser light, the majority of the laser light is absorbed in the vicinity of the surface of the resin member, and the laser light cannot reach the contact surface.

Therefore, in general, such laser-impermeable resin members are connected mechanically to each other using a bolt/nut arrangement or rivets (i.e., using so-called metal fasteners). However, such a method requires a boring operation and a fastening operation, thus resulting in a high operating cost. Furthermore, the weight of the connected product is increased due to the provision of the metal fasteners. In addition, electrolytic corrosion may be caused in a contact area between the carbon fiber and the metal fasteners. Further, it may become necessary to take measures against the different coefficients of thermal expansion of the materials.

In view of solving the above problems, there is a demand for a method that enables laser-impermeable resin members to be laser-welded with each other. However, such a welding method has not yet been accomplished.

A principal object of the present invention is to provide a resin member welding method, which is capable of satisfactorily laser-welding laser-impermeable resin members with each other.

According to an aspect of the present invention, there is provided a method for welding two laser-impermeable resin members with each other.

The welding method includes the step of overlapping the resin members with each other at least partially, with a light absorber being interposed therebetween, so as to form an overlapping portion, and also includes the step of irradiating the light absorber directly with laser light.

In the irradiating step, the light absorber absorbs the laser light and is heated and melted, heat from the melted light absorber is transferred to the resin members in the overlapping portion, and the resin members are melted in the overlapping portion.

In the present invention, the light absorber, which is interposed between the laser-impermeable resin members, is irradiated directly with laser light. The temperature of the light absorber is increased, the light absorber is melted, and both of the resin members are melted by the heat of the melted light absorber, so that the resin members are mixed with each other together with the light absorber interposed therebetween. When emission of the laser light is stopped, the light absorber and the resin members are cooled, solidified, and welded together integrally in the overlapping portion. In other words, an integrally joined portion made up of the light absorber and the resin members is formed. Thus, even if laser-impermeable resin members are to be joined, according to the present invention, such laser-impermeable resin members can be satisfactorily welded together using laser light.

The light absorber preferably is cooled by a coolant gas during the irradiating step. In this case, a surface of the light absorber can be prevented from being excessively heated, and the laser light can be partially transmitted into a deep portion within the light absorber. Therefore, the laser light can suitably be absorbed by the light absorber, and the light absorber can be heated uniformly in a depthwise direction by the laser light. Thus, the temperature of the entire light absorber can effectively be increased, and the resin members can be more efficiently welded with each other over a large area. Consequently, the resultant welded product can exhibit excellent bonding strength.

In the case of using a coolant gas, preferably, an irradiation surface of the light absorber is irradiated with laser light, and the coolant gas is supplied along the irradiation surface. In this case, transmission and absorption characteristics can be improved, and the resin members can be bonded to each other more efficiently and satisfactorily.

The irradiation angle of the laser light is controlled within a range of 0° to 45° with respect to contact surfaces between the light absorber and the resin members in the overlapping portion. The irradiation angle is defined as an angle between the contact surface and an axis of the laser light. When the irradiation angle is within the aforementioned range, laser light can be introduced to the back surface of the light absorber opposite to the irradiation surface. Thus, the temperature of the light absorber can effectively be increased, and the resin members can suitably be welded with each other. Furthermore, by controlling the laser irradiation angle within the range of 0° to 45°, the laser transmission path can be lengthened, the temperature of the light absorber can be further increased efficiently, and the light absorber can be melted rapidly and reliably.

If the overlapping portion is formed between one end of one resin member and one end of another resin member, and another end of the one resin member extends from the irradiation surface of the light absorber toward an irradiation source that emits laser light, preferably the focus of the laser light is located at a position closer to the one resin member than a thickness-direction center of the light absorber.

In this situation, compared to a case in which the focus of the laser beam is located at the thickness-direction center of the light absorber, the distance from the irradiation surface to the focus of the laser beam can be greater. Therefore, in the light absorber, the region to be melted by laser light irradiation can be expanded toward the back surface. Consequently, even in an overlapping portion formed as described above, the other end of the resin member can be prevented from interfering with the laser light, and the back surface of the light absorber can efficiently and suitably be melted.

In addition, the focus of the laser light preferably is located at a contact surface between the light absorber and the one resin member. In this case, the distance between the irradiation surface and the focus of the laser light can be further increased.

The light absorber preferably has a light absorbance of 3% to 30%. When the light absorber has a light absorbance of 3% or more, laser light can be suitably absorbed by the light absorber while preventing excessive transmission of the laser light. When the light absorber has a light absorbance of 30% or less, laser light can be suitably introduced to the back surface of the light absorber while preventing excessive absorption of the laser light. Thus, in this case, the light absorber can exhibit well-balanced transmission and absorption properties, the laser light can satisfactorily be absorbed by the light absorber, and the unabsorbed component of the laser light can reach a deep portion within the light absorber. Consequently, the temperature can efficiently be increased over the entirety of the light absorber, and the resin members can efficiently be welded with each other over a large area.

The laser-impermeable resin members may be composed of a thermoplastic resin containing a light-absorbing fiber, i.e., a carbon fiber-reinforced thermoplastic resin composite or the like.

The light absorber preferably is selected from among thermoplastic resins that are the same as the thermoplastic resins of the base materials of the resin members. In other words, the light absorber and the base materials of the resin members preferably are composed of the same thermoplastic resin. In this case, when the light absorber and the resin members are melted under laser light irradiation, the melted thermoplastic resin components in the light absorber and the resin members can readily be mixed. Therefore, the overlapping portion can easily be integrated, whereby the resultant joint exhibits excellent bonding strength.

Furthermore, since the light absorber and the base materials of the resin members have the same melting temperature, the laser light irradiation conditions for achieving satisfactory heating and melting of the light absorber and the resin members can easily be selected.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic structural view of a laser welding apparatus for carrying out a resin member welding method according to an embodiment of the present invention;

FIG. 2 is a schematic structural view of the laser welding apparatus, in which a laser irradiation unit is shown when carrying out welding of resin members having shapes different from those of FIG. 1;

FIG. 3 is an explanatory view for illustrating interference between laser light and resin members when carrying out welding of resin members having shapes different from those of FIG. 1;

FIG. 4 is a schematic structural view of the laser welding apparatus, in which the laser irradiation unit is shown when carrying out welding of the resin members shown in FIG. 3;

FIG. 5 is a view showing measurement results of a first inventive example, obtained by using thermography in order to observe a temperature change of a light absorber that is irradiated with laser light; and

FIG. 6 is a view showing measurement results of a second inventive example, obtained by using thermography in order to observe a temperature change of a light absorber that is irradiated with laser light.

### DESCRIPTION OF THE PREFERRED EMBODIMENTS

A preferred embodiment of the resin member welding method of the present invention will be described in detail below with reference to the accompanying drawings.

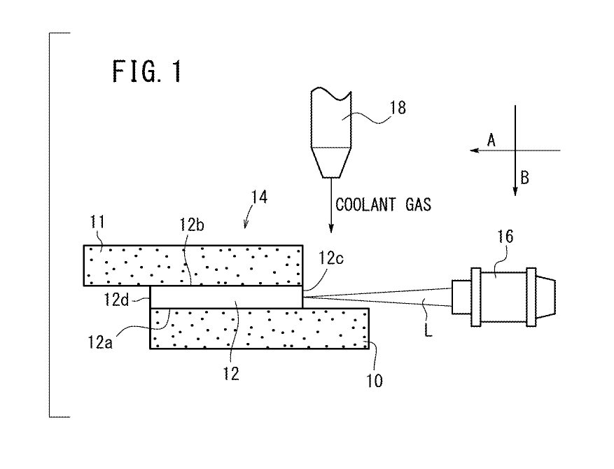

FIG. 1 is a schematic structural view of a laser welding apparatus for a resin member welding method according to the present embodiment. The laser welding apparatus is used for welding an overlapping portion 14 of respective laser-impermeable resin members 10, 11 having a light absorber 12 interposed therebetween. The laser welding apparatus contains a laser irradiation unit 16 and a blower means having a blast nozzle 18.

The resin members 10, 11 will briefly be described below. The resin members 10, 11 are composed of a carbon fiber-reinforced thermoplastic resin composite (CFRTP), for example, which is prepared by adding a reinforcing substance of carbon fibers to a base material (matrix) of thermoplastic resin. In this case, because the carbon fibers exhibit extremely high light absorption and thus can sufficiently absorb laser light, the resin members 10, 11 are impermeable to the laser light.

Preferred examples of thermoplastic resins, which may be used as the base materials of the resin members 10, 11, include polyamide resins, polyvinyl chloride resins, polypropylene resins, styrol resins, ABS resins, fluororesins, polycarbonate resins, and acetal resins. The base material of the resin member 10 and the base material of the resin member 11 may be made of the same material or different materials.

Laser light L is partially transmitted through the light absorber 12, which is interposed between the resin members 10, 11, and is partially absorbed by the light absorber 12, thereby increasing the temperature of the light absorber 12. The light absorber 12 preferably has a light absorbance of 3% to 30%. In this case, laser light L is absorbed satisfactorily by the light absorber 12, and the unabsorbed component of the laser light L reaches a deep portion in the light absorber 12. Consequently, the temperature can be increased efficiently over the entire range of the light absorber 12.

The light absorber 12 is not particularly limited, as long as the above function can be carried out by the light absorber 12. Preferred examples of materials for the light absorber 12 include the above-described thermoplastic resins, which are used as the base materials of the resin members 10, 11, i.e., polyamide resins, polyvinyl chloride resins, polypropylene resins, styrol resins, ABS resins, fluororesins, polycarbonate resins, and acetal resins. It is particularly preferred that the light absorber 12 and the base materials of the resin members 10, 11 are composed of the same thermoplastic resin. In this case, the temperatures of such members can easily be controlled during the process of emitting laser light L, and the base materials and the light absorber 12 exhibit excellent compatibility. Furthermore, integration of the welded overlapping portion 14 can be improved, and welding strength can be increased.

As described above, the light absorber 12 is interposed between the resin members 10, 11. Therefore, as shown in FIG. 1, the lower surface 12a and the upper surface 12b of the light absorber 12 are brought into contact respectively with the resin members 10, 11. Hence, the lower surface 12a and the upper surface 12b act as contact surfaces.

Meanwhile, the side surfaces of the light absorber 12 remain exposed. One of the exposed side surfaces, which faces toward the laser irradiation unit 16, will hereinafter be referred to as an “irradiation surface 12c”, whereas the other exposed side surface, which is opposite to the irradiation surface 12c, will hereinafter be referred to as an “irradiation back surface 12d”.

The laser irradiation unit 16 is operated to emit laser light L toward the exposed irradiation surface 12c of the light absorber 12, which is not in contact with the resin members 10, 11. Incidentally, if the irradiation surface 12c has a reflectance of 5% to 25%, reflection of laser light L can appropriately be prevented.

The laser irradiation unit 16 is not particularly limited, as long as the laser irradiation unit 16 is capable of emitting laser light L. For example, the laser irradiation unit 16 may contain a diode, an yttrium aluminum garnet (YAG), or the like.

The blast nozzle 18 is used for discharging a compressed gas, which serves as a coolant gas, toward the light absorber 12. It should be understood that the blast nozzle 18 is connected with a non-illustrated compressed gas source. Preferably, the coolant gas is an inexpensive gas, such as air or nitrogen gas.

In the present embodiment, the coolant gas is supplied to the irradiation surface 12c during the process of emitting laser light L toward the irradiation surface 12c.

The welding method of the present embodiment is carried out in the following manner using the laser welding apparatus, which is constructed basically as described above.

First, as shown in FIG. 1, the resin members 10, 11, which are to be welded together, are stacked with the light absorber 12 interposed therebetween, so as to form the overlapping portion 14.

Then, the coolant gas is discharged from the blast nozzle 18 while laser light L is emitted from the laser irradiation unit 16. The coolant gas flows along the irradiation surface 12c of the light absorber 12 (in the direction of the arrow B). The laser light L is introduced through the irradiation surface 12c into the light absorber 12.

A portion of the laser light L, which is introduced into the light absorber 12, is absorbed by the light absorber 12, whereas the residual portion thereof is transmitted toward the irradiation back surface 12d in the horizontal direction (the direction of the arrow A shown in FIG. 1). Such absorption and transmission can be easily achieved if the light absorber 12 has a light absorbance of 3% to 30%.

On the other hand, the light absorber 12 absorbs laser light L, thereby increasing the temperature of the light absorber 12. The laser light L reaches the irradiation back surface 12d, i.e., a deep portion in the irradiation direction (in the direction of the arrow A shown in FIG. 1). Consequently, the temperature of the light absorber 12 is increased over the entire region from the irradiation surface 12c to the irradiation back surface 12d. By controlling the laser irradiation angle from 0° to 45°, the laser transmission path can be lengthened, the temperature of the light absorber 12 can further be increased efficiently, and the light absorber 12 can be melted rapidly and reliably.

Furthermore, in the present embodiment, laser light L is emitted while the irradiation surface 12c is cooled by supply of the coolant gas. In this case, the temperature of the deep portion in the light absorber 12 can suitably be increased.

During this step, by controlling the wavelength, irradiation intensity, focus, and the like of the laser light L, the light absorber 12 is heated to a temperature that is equal to or higher than the melting temperatures of the light absorber 12 and the thermoplastic resins, which are used as base materials of the resin members 10, 11. For example, in the case that the material of the light absorber 12 and the base materials of the resin members 10, 11 are all composed of nylon 6 (a polyamide resin PA6 having a melting temperature of 220° C. to 225° C.), the light absorber 12 preferably is heated to a temperature of 250° C. to 400° C. by the laser light L.

Thus, the light absorber 12 preferably is composed of a thermoplastic resin having a melting temperature that is relatively close to (equal to or higher than) the melting temperatures of the base materials of the resin members 10, 11. In this case, the light absorber 12 and the resin members 10, 11 can suitably be melted without suffering from heat degradation (molecular weight reduction, oxidation, etc.) In particular, in the case that the light absorber 12 and the base materials of the resin members 10, 11 are composed of the same thermoplastic resin, irradiation conditions for the laser light L can easily be set, and the temperatures of the members can easily be controlled during the process of emitting laser light L.

In this manner, when the temperature of the light absorber 12 is increased, the light absorber 12 is melted. Further, heat from the light absorber 12 is transferred to the resin members 10, 11 from the contact surfaces of the lower surface 12a and the upper surface 12b. Due to such heat transfer, the overlapping portion 14 of the resin members 10, 11 is melted. Thus, the resin members 10, 11 are melted, and the melted members (e.g., the melted thermoplastic resins) are mixed with each other.

Thereafter, emission of the laser light L is stopped, so that the melted light absorber 12 and the melted resin members 10, 11 are cooled and solidified. As a result, the light absorber 12 and the resin members 10, 11 are integrally bonded to each other, and the resin members 10, 11 are welded to each other within the overlapping portion 14. Thus, even if the resin members 10, 11 are impermeable to laser light L, the resin members 10, 11 can be welded easily and suitably by directly irradiating the light absorber 12, which is interposed between the resin members 10, 11, with laser light L in order to melt the light absorber 12.

For example, in the case that the resin members 10, 11 are bonded using a common adhesive, the resin members 10, 11 are not integrated in the joint, and thus the resin members 10, 11 remain independent from each other.

In contrast, in the welding method according to the present embodiment, the light absorber 12 and the resin members 10, 11 in the overlapping portion 14 are melted, cooled, and solidified, so as to become bonded and integrated. In other words, the resin members 10, 11 are connected in an integral manner with the light absorber 12 interposed therebetween. Consequently, a joint with satisfactory bonding strength can be formed in the overlapping portion 14.

As described above, the light absorber 12 and the base materials of the resin members 10, 11 can all be composed of the same thermoplastic resin. Therefore, the melted resin members 10, 11 and the melted light absorber 12 can be suitably mixed and satisfactorily integrated in the overlapping portion 14. Consequently, the bonding strength and bonding reliability of the resin members 10, 11 can be improved sufficiently.

The present invention is not particularly limited to the above-described embodiment. Various changes and modifications may be made to the embodiment without departing from the scope of the invention.

In the above embodiment, laser light L is emitted in a direction perpendicular to the irradiation surface 12c (in the direction of the arrow B). Thus, the irradiation angle of the laser light L is 0° with respect to the contact surfaces of the lower surface 12a and the upper surface 12b.

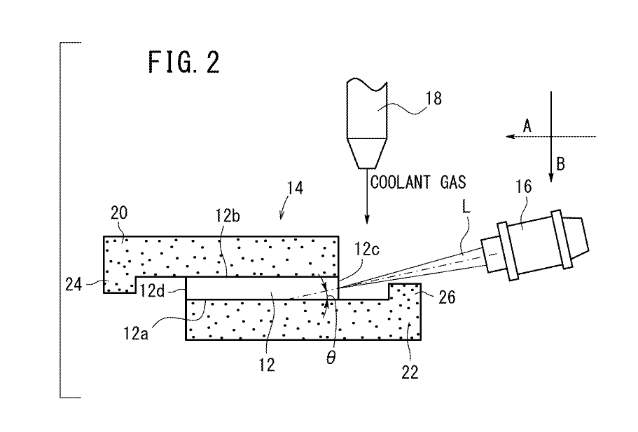

However, for example, in the case that the welding resin members 20, 22 are formed with protrusions 24, 26, as shown in FIG. 2, the irradiation surface 12c is covered by the protrusion 26, and the irradiation surface 12c cannot be irradiated with laser light L at an irradiation angle θ of 0°.

In this case, the irradiation angle θ may be controlled within a range of 0° to 45°. In such a range, laser light L can suitably be introduced to the irradiation back surface 12d of the light absorber 12.

When the light absorber 12 is irradiated with laser light L, the temperature of the light absorber 12 starts to rise in the vicinity of the focus of the laser light L. More specifically, the focus of the laser light L is located at the center of the melted area of the light absorber 12. Therefore, preferably, the focus of the laser light L is placed at a position such that the light absorber 12 is heated over an entire region thereof from the irradiation surface 12c to the irradiation back surface 12d.

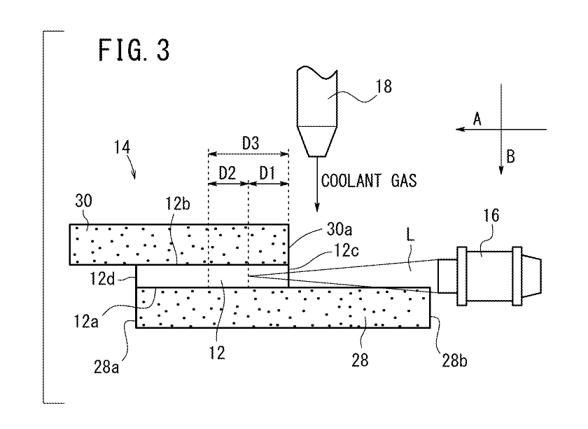

As shown in FIG. 3, the overlapping portion 14 may be formed by overlapping only a small portion of a resin member 28 with a portion of a resin member 30. More specifically, the overlapping portion 14 may be formed between one end 28a of the resin member 28 and one end 30a of the resin member 30, while in addition, the other end 28b of the resin member 28 extends from the irradiation surface 12c toward the laser irradiation unit 16. When the other end 28b of the resin member 28 interferes with the laser light L, it is difficult for the light absorber 12 to be melted satisfactorily. Therefore, it is necessary for the laser irradiation unit 16 to be located at a certain distance from the other end 28b of the resin member 28, so as to prevent the other end 28b from interfering with the laser light L.

However, in this case, since the other end 28b of the resin member 28 extends toward the laser irradiation unit 16 as described above, the distance between the laser irradiation unit 16 and the irradiation surface 12c is increased. As a result, the focal position of the laser light L in the light absorber 12 is closer to the irradiation surface 12c, and the distance between the focus and the irradiation surface 12c (i.e., the depth D1 of the focus) is reduced. In this case, a melting region D2, which extends from the focus of the laser light L toward the irradiation back surface 12d, cannot reach the irradiation back surface 12d. Consequently, the irradiation back surface 12d of the light absorber 12 cannot be suitably melted.

To avoid such a problem, for example, the irradiation intensity of the laser light L may be increased so as to expand the overall melting region D3 within the light absorber 12. However, in this case, the temperature of the light absorber 12 is increased excessively in the vicinity of the focus around the irradiation surface 12c, and the light absorber 12 cannot be suitably melted.

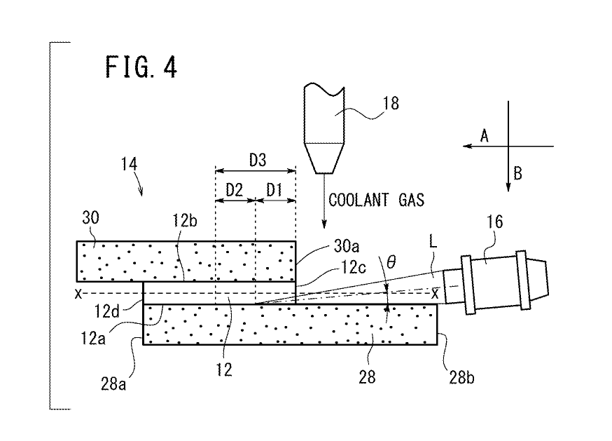

Accordingly, in the case of welding the above overlapping portion 14 containing the resin members 28, 30, preferably, the irradiation angle θ and the focal position of the laser light L are controlled appropriately, as shown in FIG. 4.

More specifically, the irradiation angle θ is controlled within a range of 0° to 45°. In this case, the other end 28b of the resin member 28 can be prevented from interfering with the laser light L, and the laser light L can suitably be introduced to the irradiation back surface 12d of the light absorber 12.

In addition, the focus of the laser light L is located at a position closer to the lower surface 12a than a center X between the lower surface 12a and the upper surface 12b of the light absorber 12. More preferably, the focus of the laser light L is located on the lower surface 12a (contact surface). Compared to the case in which the focus is located at the center X, the depth D1 of the focus, which is located at a position closer to the lower surface 12a, can be made greater. Therefore, the melting region D3 of the light absorber 12 can be expanded toward the irradiation back surface 12d, such that the entirety of the light absorber 12 can be melted suitably and efficiently.

Further, in the above embodiment, the coolant gas is supplied along the irradiation surface 12c of the light absorber 12 (in the direction B shown in FIG. 1). However, the direction of flow of the coolant gas is not particularly limited, insofar as the irradiation surface 12c can be cooled by the coolant gas. For example, the coolant gas may be supplied in a direction perpendicular to the irradiation surface 12c (the direction A), which is the same as the axial direction of the laser light L.

Furthermore, laser light L may be emitted toward the irradiation surface 12c without supplying a coolant gas to the light absorber 12. In the event that the laser light L cannot be introduced sufficiently to the region from the irradiation surface 12c to the irradiation back surface 12d of the light absorber 12, depending on the sizes and materials of the resin members 10, 11 and the light absorber 12, the laser irradiation unit 16 may be rotated relative to the resin members 10, 11 and the light absorber 12, so as to emit laser light L toward the irradiation back surface 12d.

The light absorber 12 may contain a plurality of materials having different absorbances, such that the laser light L absorption of the light absorber 12 increases from the irradiation surface 12c to the irradiation back surface 12d. In general, the intensity of the laser light L is reduced in the light absorber 12 as the laser light L is transmitted through and absorbed by the light absorber 12. Consequently, the laser light L has a low intensity in a deep portion of the light absorber 12 in the irradiation direction. The light absorber 12, which uses the above materials, can exhibit a high laser light L absorbance in the deep portion, so that the laser light L can be absorbed efficiently by the light absorber 12, thereby enabling the light absorber 12 to be effectively melted. Consequently, the resin members 10, 11 can be welded with each other more efficiently and appropriately.

Furthermore, the resin members 10, 11 may be welded together while the light absorber 12 is fed between the resin members 10, 11.

In addition, the carbon fibers in the resin members 10, 11 may be made up from discontinuous fibers. In the above embodiment, the resin members 10, 11 are composed of CFRTP. However, the material of the resin members 10, 11 is not particularly limited to CFRTP, insofar as the resin members 10, 11 are composed of a resin material that is impermeable to laser light L.

Further, in the above embodiment, the overlapping portion 14 is formed by overlapping an end of the resin member 10 with an end of the resin member 11. However, the entirety of the resin members 10, 11 from one end to the other end may be overlapped in order to form the overlapping portion 14.

### EXAMPLE 1

A light absorber containing PA6 was interposed between resin members containing carbon fiber and PA6 in order to form an overlapping portion. Thereafter, laser light was emitted toward the light absorber while a coolant gas was supplied to the light absorber, and the resin members were welded with each other. The light absorber had a light absorbance of 3.0%.

Laser light was emitted under the following conditions. The output of a laser irradiation unit was 100 W, the spot diameter φ was 0.6 mm, the scan rate on the irradiation surface was 2 m/min, the irradiation angle (with respect to the contact surface) was 0°, and the focal position was controlled within a range from the irradiation surface (0 mm) to an inner portion of the light absorber (10 mm).

Under the above conditions, the light absorber was heated to 250° C.

Further, according to the method of Example 1, the resin members were welded while compressed air was supplied as a coolant gas at a flow rate of 30 l/min along the irradiation surface of the light absorber.

### EXAMPLE 2

According to the method of Example 2, the resin members were welded in the same manner as in Example 1, except that laser light was emitted toward the light absorber without supplying the coolant gas.

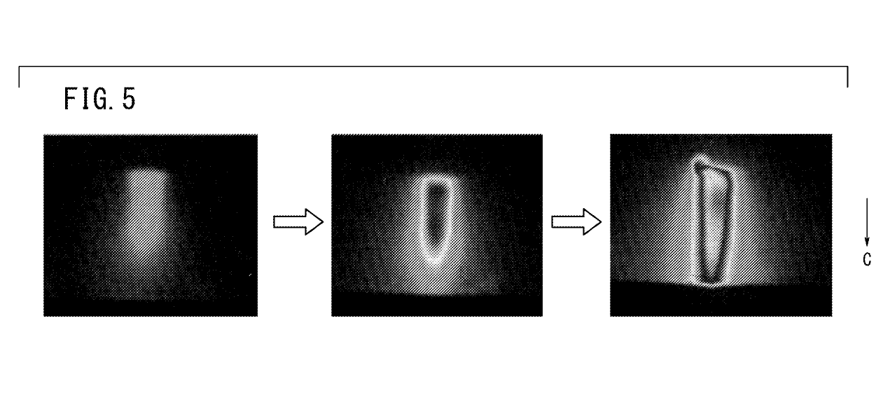

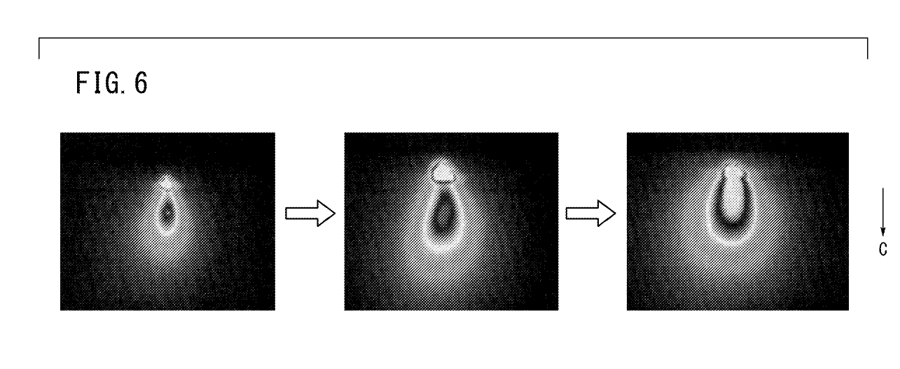

In Examples 1 and 2, the temperature change of the light absorber when irradiated with laser light irradiation was observed using thermography. The results of Example 1 are shown in FIG. 5, and the results of Example 2 are shown in FIG. 6. As shown in FIGS. 5 and 6, the temperature change of the light absorber was observed after the temperature of the irradiation surface thereof started to increase and until the temperature of the opposite back surface started to increase, and while laser light was emitted toward the light absorber in the direction of the arrow C.

As shown in FIGS. 5 and 6, the temperature of the light absorber was increased more rapidly in Example 1 than in Example 2, even in a deep portion thereof in the irradiation direction. Thus, as compared with the method in which the coolant was not used, the entire light absorber can be heated more effectively, and the resin members can be welded together more efficiently in the method in which laser light is emitted while supplying the coolant gas for cooling the light absorber.

Although certain preferred embodiments of the present invention have been shown and described in detail, it should be understood that various changes and modifications may be made therein without departing from the scope of the appended claims.

What is claimed is:

1. A method for welding two laser-impermeable resin members, comprising the steps of:
overlapping the resin members with each other at least partially, with a light absorber being interposed therebetween, so as to form an overlapping portion; and
irradiating the light absorber directly with laser light,
wherein, in the irradiating step, the light absorber absorbs the laser light and is heated and melted, heat from the melted light absorber is transferred to the resin members in the overlapping portion, and the resin members are melted in the overlapping portion.

2. The method according to claim 1, wherein, in the irradiating step, the light absorber is cooled by a coolant gas.

3. The method according to claim 2, wherein, in the irradiating step, an irradiation surface of the light absorber is irradiated with the laser light, and the coolant gas is supplied along the irradiation surface.

4. The method according to claim 1, wherein an irradiation angle of the laser light is controlled within a range of 0° to 45° with respect to contact surfaces between the light absorber and the resin members in the overlapping portion.

5. The method according to claim 4, wherein the overlapping portion is formed between one end of one resin member and one end of another resin member, another end of the one resin member extends from an irradiation surface of the light absorber toward an irradiation source that emits the laser light, and a focus of the laser light is located at a position closer to the one resin member than a thickness-direction center of the light absorber in the overlapping portion.

6. The method according to claim 5, wherein the focus of the laser light is located at a contact surface between the light absorber and the one resin member.

7. The method according to claim 1, wherein the light absorber has a light absorbance of 3% to 30%.

8. The method according to claim 1, wherein the resin members each contain a light-absorbing fiber and a thermoplastic resin, and the light absorber contains the same thermoplastic resin as the resin members.
